(19) United States
(12) Patent Application Publication
(10) Pub. No.: US 2024/0199133 A1
(43) Pub. Date: Jun. 20, 2024

(54) STRUCTURE FOR COVERING FENDER CONNECTION PORTION

(71) Applicants: Hyundai Motor Company, Seoul (KR); Kia Corporation, Seoul (KR)

(72) Inventors: Yun-Jeong Lee, Hwaseong-si (KR); Kyung-Won Kim, Seongnam-si (KR)

(21) Appl. No.: 18/490,277

(22) Filed: Oct. 19, 2023

(30) Foreign Application Priority Data
Dec. 14, 2022 (KR) 10-2022-0175232

(51) Int. Cl. B62D 25/16; B60Q 1/04; B62D 25/18

(52) U.S. Cl. CPC B62D 25/163; B60Q 1/0408; B62D 25/18

(57) ABSTRACT

An embodiment structure for covering a fender connection portion includes a fender of a vehicle, a fender apron on which the fender is mounted, and a cover member, wherein an inner end of the fender apron in a width direction of the vehicle is fastened to the cover member and the fender is fastened to the cover member.

### CROSS-REFERENCE TO RELATED APPLICATIONS

This application claims the benefit of Korean Patent Application No. 10-2022-0175232, filed on Dec. 14, 2022, which application is hereby incorporated herein by reference.

### TECHNICAL FIELD

The present disclosure relates to a structure for covering a fender connection portion.

### BACKGROUND

When a hood of a vehicle is opened, a portion in which a fender is connected to a body side is exposed.

As shown in FIGS. 1 and 2, a fender 120 is fastened to a fender apron 110 using fastening bolts. When the hood of the vehicle is opened, a fender mounting bracket 111, an outer plate stiffness reinforcing bracket 113, a headlamp mounting bracket 112, etc. for mounting the fender 120 to the fender apron 110 are visible, and a space between the fender 120 and the fender apron 110 is exposed as it is. Therefore, the exterior quality is degraded, and a fender side cover 130 is applied to mid-size vehicles or larger to cover space between the fender 120 and the fender apron 110.

The fender side cover 130 made of plastic, etc. is mounted to cover not only the fender mounting bracket 111, the outer plate stiffness reinforcing bracket 113, and the headlamp mounting bracket 112 but also their surroundings.

However, since the fender side cover 130 is assembled separately, in order to apply the fender side cover 130, not only the cost increases due to the manufacturing of the fender side cover 130, but also the production cost increases due to an additional process for assembling the fender side cover 130. Therefore, it is difficult to apply the fender side cover 130 to small size vehicles due to the production cost.

In addition, even when the separate fender side cover 130 is applied, various mounting brackets, such as the fender mounting bracket 111, the outer plate stiffness reinforcing bracket 113, and the headlamp mounting bracket 112 are applied, the number of components and the number of assembling operations increase. Therefore, there is a problem in that a gap step occurs in the exterior due to an assembly tolerance.

### SUMMARY

The present disclosure relates to a structure for covering a fender connection portion. Particular embodiments relate to a structure for covering a fender connection portion to cover a portion in which a fender is connected to a body even without applying a separate cover.

Embodiments of the present disclosure solve problems in the art and provide a structure for covering a fender connection portion in which a cover member extending from a body side toward a fender may be formed, the fender may cover a portion in which the fender is connected to the body through the cover member, and the fender may be fastened even without using a mounting bracket.

A structure for covering a fender connection portion according to embodiments of the present disclosure includes a fender of a vehicle, a fender apron on which the fender is mounted, and a cover member to which an inner end of the fender apron in a width direction of the vehicle is fastened and to which the fender is fastened.

The cover member may include a fastening portion fastened to the fender apron and a fender mounting portion formed in a longitudinal direction of the vehicle from the fastening portion on an outside of the vehicle in the width direction and fastened to an inner end of the fender.

The fastening portion may be formed stepwise with the fender mounting portion.

The fastening portion may be fastened to an upper end of the fender apron.

The cover member may have a bent portion bent downward from the fender mounting portion formed on the outside of the vehicle in the width direction.

The inner end of the fender may overlap an upper surface of the fender mounting portion and may be fastened to the fender and the fender mounting portion.

A plurality of fastening holes to which the fender is fastened may be formed in the fender mounting portion at intervals in the longitudinal direction of the vehicle.

The structure for covering the fender connection portion may further include a bead portion formed to be bent from the fender mounting portion to be positioned under the fender mounting portion.

The structure for covering the fender connection portion may further include an outer plate stiffness reinforcing portion formed to be bent upward from the fastening portion on a rear end of the cover member in the longitudinal direction of the vehicle.

The structure for covering the fender connection portion may further include a headlamp mounting portion to which a rear end of a headlamp is fastened on a front end of the cover member in the longitudinal direction of the vehicle.

An outer plate supporting portion extending from the fender mounting portion in the width direction of the vehicle and in contact with an inner surface of the fender may be formed.

According to the structure for covering the fender connection portion according to embodiments of the present disclosure having the above configuration, the cover member can cover the portion in which the fender is connected to the body even without applying the separate fender side cover, thereby improving the exterior when the hood is opened.

Particularly, even in the small size vehicle in which it is difficult to apply the cover due to cost burden, the portion in which the fender is connected can be covered.

In addition, since the fender and the headlamp are fastened using the cover member, the separate mounting bracket is not required, and thus it is possible to reduce the number of components, simplify the assembling process, and improve the assembly quality.

In addition, it is possible to block the noise introduced through the space between the fender and the hood upon traveling.

### BRIEF DESCRIPTION OF THE DRAWINGS

FIG. 1 is a perspective view showing a state in which a fender side cover is mounted according to the related art.

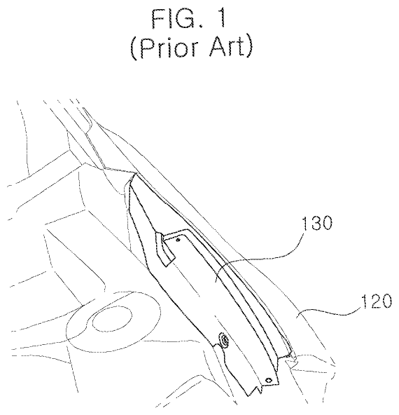

FIG. 2 is an exploded perspective view showing a state before the fender side cover and a fender are assembled according to the related art.

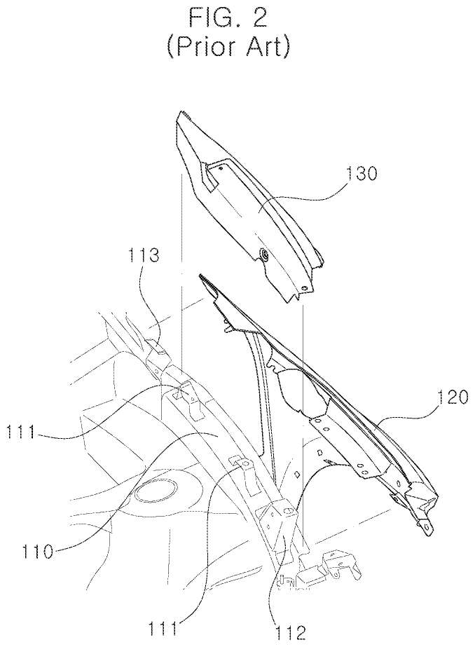

FIG. 3 is a perspective view showing a structure for covering a fender connection portion according to embodiments of the present disclosure.

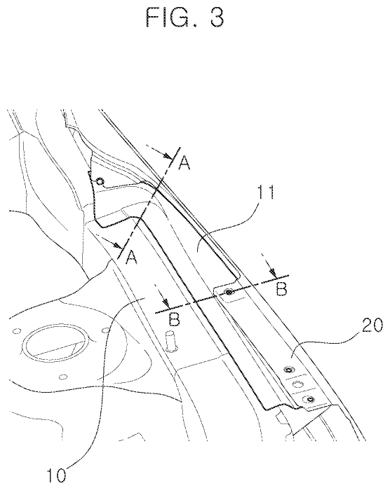

FIG. 4 is an exploded perspective view showing a state in which the fender and a headlamp are fastened to the structure for covering the fender connection portion according to embodiments of the present disclosure.

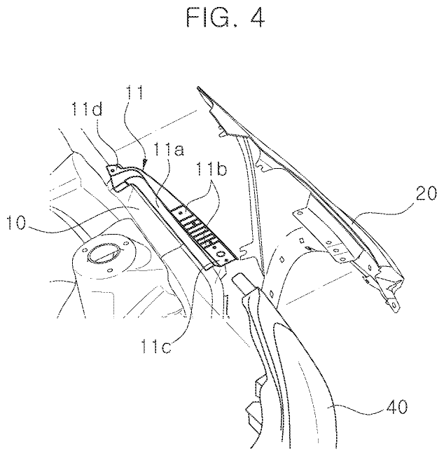

FIG. 5 is a perspective view of a cover member applied to the structure for covering the fender connection portion according to embodiments of the present disclosure.

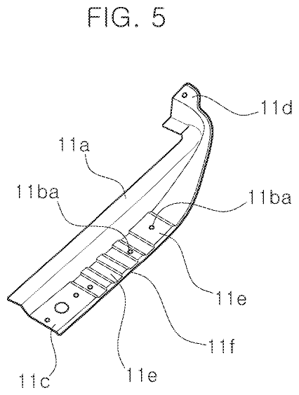

FIG. 6 is a cross-sectional view along line I-I in FIG. 3.

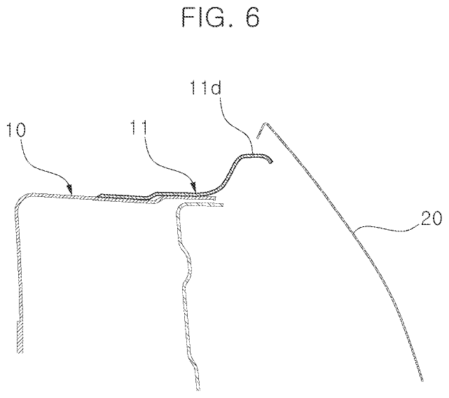

FIG. 7 is a cross-sectional view along line II-II in FIG. 3.

FIG. 8 is a cross-sectional view showing the structure for covering the fender connection portion according to another embodiment of the present disclosure.

### DETAILED DESCRIPTION OF ILLUSTRATIVE EMBODIMENTS

Hereinafter, a structure for covering a fender connection portion according to embodiments of the present disclosure will be described in detail with reference to the accompanying drawings.

The structure for covering the fender connection portion according to embodiments of the present disclosure includes a fender 20 of a vehicle, a fender apron 10 on which the fender 20 is mounted, and a cover member 11 to an inner end of the fender apron 10 in a width direction of the vehicle is fastened and to which the fender 20 is fastened.

The fender 20 forms an exterior of a circumference of a wheel of the vehicle. The fender 20 is fastened to a body of the vehicle.

The fender apron 10 forms a circumference of an engine room of the vehicle and has a wheel house in which the wheels of the vehicle are mounted.

The cover member 11 integrated with the fender apron 10 is fastened to a portion in which the fender 20 is fastened to the body, that is, an upper end of the fender apron 10. The cover member 11 covers a portion in which the fender apron 10 and the fender 20 are connected so that the portion is invisible.

The cover member 11 serves to not only cover the portion in which the fender 20 and the fender apron 10 are connected, but also allow the upper end of the fender 20 to be connected to the fender apron 10 through the cover member 11.

Specifically describing a shape of the cover member 11, the cover member 11 includes a fastening portion 11a fastened to the fender apron 10, a fender mounting portion 11b formed in a longitudinal direction of the vehicle from an outside of the vehicle in the width direction and fastened to an inner end of the fender 20, and a bent portion 11f bent downward from the fender mounting portion 11b to the outside of the vehicle in the width direction.

The fastening portion 11a of the cover member 11 is positioned inside the vehicle in the width direction and formed in the longitudinal direction of the vehicle. As the fastening portion 11a is fastened to the upper end of the fender apron 10 through welding, etc., the cover member 11 is integrally fastened to the body side, that is, the fender apron 10.

The fender mounting portion 11b is positioned on the outside of the vehicle in the width direction from the fastening portion 11a. Like the fastening portion 11a, the fender mounting portion 11b is also formed in the longitudinal direction of the vehicle. Fastening holes 11ba are formed in the fender mounting portion 11b so that the fender 20 may be fastened to the cover member 11. The fastening holes 11ba are formed in the cover member 11 at intervals in the longitudinal direction of the vehicle so that the fender 20 and the cover member 11 may be fastened at a plurality of points.

The bent portion 11f bent downward from the fender mounting portion 11b is formed on the outside of the vehicle in the width direction. The fastening portion 11a is formed stepwise with the fender mounting portion 11b so that the fender mounting portion 11b is positioned under the fastening portion 11a, and since the bent portion 11f is formed on the end of the fender mounting portion 11b, a cross section of the cover member 11 is formed stepwise from the fastening portion 11a to the bent portion 11f so that the cover member 11 has stiffness.

Meanwhile, in order to fasten the fender 20 to the fender apron 10, when the fender 20 is loaded to the fender apron 10, the bent portion 11f guides the end of the fender 20, and thus the fender 20 easily enters the fender apron 10 without interfering with the fender apron 10, thereby improving assemblability.

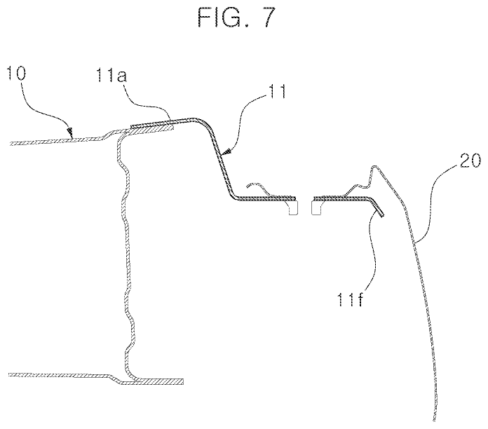

Since the fender 20 enters an upper surface of the fender apron 10 by the bent portion 11f, the fender 20 overlaps the upper surface of the fender apron 10 when the entry of the fender 20 is completed (see FIG. 7). In this state, the fender 20 is fastened to the cover member 11 using fastening members such as fastening bolts, and thus is fastened to the fender apron 10 that is the body side.

A bead portion 11e is formed to be bent from the fender mounting portion 11b to be positioned under the fender mounting portion 11b. A gap is formed between the fender 20 and the cover member 11 by the bead portion 11e at the position at which the bead portion 11e is formed so that an electrodeposition liquid may be easily discharged in the painting process. When the electrodepositing liquid is dried in a state of being stagnant between the fender 20 and the fender mounting portion 11b, the stagnant electrodepositing liquid solidifies and remains on a painted surface, resulting in poor exterior. However, by reducing a contact area between the cover member 11 and the fender 20 by the bead portion 11e through the gap, the electrodepositing liquid can be easily removed.

The outer plate stiffness reinforcing portion 11d is formed to be bent upward from the fastening portion 11a on a rear end of the cover member 11 in the longitudinal direction of the vehicle. Since the outer plate stiffness reinforcing portion 11d is formed to be bent upward from the rear end of the cover member 11, the outer plate stiffness reinforcing portion 11d serves to cover the space between the fender 20 and the fender apron 10. In addition, the stiffness of the rear end of the cover member 11 can be improved by the bent outer plate stiffness reinforcing portion 11d.

The headlamp mounting portion 11c is formed on a front end of the cover member 11 in the longitudinal direction of the vehicle. By using the headlamp mounting portion 11c, the headlamp mounting portion 11c and the rear end of a headlamp 40 are fastened so that the body is fastened to one side of the headlamp 40.

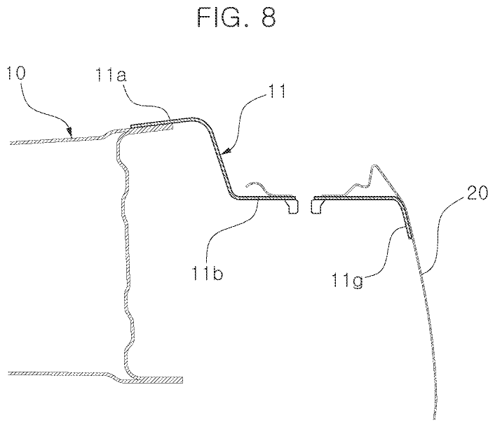

FIG. 8 shows the structure for covering the fender connection portion according to another embodiment of the present disclosure.

Since the fender 20 is fastened to the cover member 11 formed on the fender apron 10, the fact that the fender 20 is fastened to the body side is the same as in the above-described embodiment.

In the embodiment, the shape of the cover member 11 is different, the bent portion 11f is removed from the cover member 11, the fender mounting portion 11b extends in the width direction of the vehicle, and thus an outer plate supporting portion 11g extending from the fender mounting portion 11b is formed on the inner surface of the fender 20. Since portions other than the outer plate supporting portion 11g are the same as those in the above-described embodiment, a description thereof will be omitted.

The outer plate supporting portion 11g extends from the fender mounting portion 11b and is in direct contact with the inner surface of the fender 20 so that the cover member 11 supports the fender 20.

Since the outer plate supporting portion 11g allows the cover member 11 to support the fender 20, a separate outer plate stiffness bracket is not applied, and thus it is possible to provide the required stiffness even without reducing the number of components.

What is claimed is:

1. A structure for covering a fender connection portion, the structure comprising:
a fender of a vehicle;
a fender apron on which the fender is mounted; and
a cover member, wherein an inner end of the fender apron in a width direction of the vehicle is fastened to the cover member and the fender is fastened to the cover member.

2. The structure of claim 1, wherein the cover member comprises:
a fastening portion fastened to the fender apron; and
a fender mounting portion extending in a longitudinal direction of the vehicle from the fastening portion on an outside of the vehicle in the width direction and fastened to an inner end of the fender.

3. The structure of claim 2, wherein the fastening portion is disposed stepwise with the fender mounting portion.

4. The structure of claim 2, wherein the fastening portion is fastened to an upper end of the fender apron.

5. The structure of claim 2, wherein the cover member has a bent portion bent downward from the fender mounting portion on the outside of the vehicle in the width direction.

6. The structure of claim 5, wherein the inner end of the fender overlaps an upper surface of the fender mounting portion and is fastened to the fender and the fender mounting portion.

7. The structure of claim 2, further comprising a plurality of fastening holes in the fender mounting portion at intervals in the longitudinal direction of the vehicle, wherein the fender is fastened to the plurality of fastening holes.

8. The structure of claim 2, further comprising a bead portion bent from the fender mounting portion to be positioned under the fender mounting portion.

9. The structure of claim 2, further comprising an outer plate stiffness reinforcing portion bent upward from the fastening portion on a rear end of the cover member in the longitudinal direction of the vehicle.

10. The structure of claim 2, further comprising:
a headlamp mounting portion on a front end of the cover member in the longitudinal direction of the vehicle; and
a headlamp having a rear end fastened to the headlamp mounting portion.

11. The structure of claim 2, further comprising an outer plate supporting portion extending from the fender mounting portion in the width direction of the vehicle and in contact with an inner surface of the fender.

12. A vehicle comprising:
a vehicle body;
a cover member;
a fender apron having an inner end in a width direction of the vehicle fastened to the cover member, wherein the fender apron comprises a wheel house in which a wheel of the vehicle is mounted; and
a fender mounted on the fender apron, fastened to the vehicle body, and fastened to the cover member.

13. The vehicle of claim 12, wherein the cover member comprises:
a fastening portion fastened to the fender apron; and
a fender mounting portion extending in a longitudinal direction of the vehicle from the fastening portion on an outside of the vehicle in the width direction and fastened to an inner end of the fender.

14. The vehicle of claim 13, wherein the fastening portion is disposed stepwise with the fender mounting portion.

15. The vehicle of claim 13, wherein the fastening portion is fastened to an upper end of the fender apron.

16. The vehicle of claim 13, wherein the cover member has a bent portion bent downward from the fender mounting portion on the outside of the vehicle in the width direction.

17. The vehicle of claim 16, wherein the inner end of the fender overlaps an upper surface of the fender mounting portion and is fastened to the fender and the fender mounting portion.

18. The vehicle of claim 13, further comprising a plurality of fastening holes in the fender mounting portion at intervals in the longitudinal direction of the vehicle, wherein the fender is fastened to the plurality of fastening holes.

19. The vehicle of claim 13, further comprising:
a bead portion bent from the fender mounting portion to be positioned under the fender mounting portion; and
an outer plate stiffness reinforcing portion bent upward from the fastening portion on a rear end of the cover member in the longitudinal direction of the vehicle.

20. The vehicle of claim 13, further comprising:
a headlamp mounting portion on a front end of the cover member in the longitudinal direction of the vehicle; and
a headlamp having a rear end fastened to the headlamp mounting portion.
